(19) United States
(12) Patent Application Publication
(10) Pub. No.: US 2015/0213041 A1
(43) Pub. Date: Jul. 30, 2015

(54) SEARCH SUGGESTION RANKINGS

(71) Applicant: Google Inc., Mountain View, CA (US)

(72) Inventors: Abhinandan Sujit DAS, Sunnyvale, CA (US); Othar Hansson, Sunnyvale, CA (US); Bartlomiej Niechwiej, Fremont, CA (US); Harry Fung, Saratoga, CA (US); Mark Roth Pearson, San Francisco, CA (US); David Charles Black, Mountain View, CA (US)

(73) Assignee: Google Inc., Mountain View, CA (US)

(21) Appl. No.: 13/843,167

(22) Filed: Mar. 15, 2013

(51) Int. Cl. G06F 17/30

(52) U.S. Cl. CPC G06F 17/3097

(57) ABSTRACT

Methods for ranking search suggestions are provided. In one aspect, a method includes receiving a search input and identifying at least one suggestion responsive to the search input from each of a plurality of suggestion sources. Each suggestion has an associated probability ranking value based on a likelihood that the search input is for a query or a likelihood that the search input is for an address. The method also includes providing, for display, each of the suggestions according to the associated probability ranking value of the suggestion. Systems and machine-readable media are also provided.

### BACKGROUND

1. Field

The present disclosure generally relates to the transmission of data over a network, and more particularly to the use of a computing device to communicate over a network.

2. Description of the Related Art

Users commonly search for content on the Internet using Internet search engines. A user may type a search input into an input field and submit the query in order for the search input to be searched by the search engine. Certain search engines provide suggestions, such as queries or addresses (e.g., URLs), to a user in response to a search input from the user when the user enters the search input into an input field of the search engine. For example, a user typing the query “th” into an input field may be provided with the search suggestions of “thesaurus” or “the dark rises” below the input field. Suggestions may be provided from several sources, such as a user's search history, search results based on what the user has typed so far, or search suggestions from the history of other users based on what the user has typed so far. Suggestions are often assigned scores that are fixed according to the source of the suggestion and relative to the other sources of suggestions. For example, a URL suggestion based on a user's search history always ranks higher than a search suggestion for what the user has typed so far, which ranks higher than search suggestions from the history of other users based on what the user has typed so far. Furthermore, suggestions are usually grouped together based on the source of the suggestion.

### SUMMARY

According to one embodiment of the present disclosure, a computer-implemented method for ranking search suggestions is provided. The method includes receiving a search input and identifying at least one suggestion responsive to the search input from each of a plurality of suggestion sources. Each suggestion has an associated probability ranking value based on a likelihood that the search input is for a query or a likelihood that the search input is for an address. The method also includes providing, for display, each of the suggestions according to the associated probability ranking value of the suggestion.

According to another embodiment of the present disclosure, a system for ranking search suggestions is provided. The system includes a memory that includes instructions, and a processor. The processor is configured to execute the instructions to receive a search input in an input field from a user and identify at least one suggestion responsive to the search input from each of a plurality of suggestion sources includes a query or address from the user's search history, search results based on what the user has typed in the input field, or search suggestions for what the user has typed in the input field based on a search history of a plurality of other users. Each suggestion has an associated probability ranking value based on a likelihood that the search input is for a query or a likelihood that the search input is for an address. The processor is also configured to execute the instructions to provide, for display, each of the suggestions according to the associated probability ranking value of the suggestion.

According to a further embodiment of the present disclosure, a machine-readable storage medium includes machine-readable instructions for causing a processor to execute a method for ranking search suggestions is provided. The method includes receiving a search input in an input field on a device from a user and identifying at least one suggestion responsive to the search input from each of a plurality of suggestion sources includes a query or address from the user's search history, search results based on what the user has typed in the input field, or search suggestions for what the user has typed in the input field based on a search history of a plurality of other users. Each suggestion has an associated probability ranking value based on: a likelihood that the search input is for a query or a likelihood that the search input is for an address, a probability, based on a search history of a plurality of users, that the search input is for a repeated address, repeated query, novel address, or novel query set specific to the user. The probability that the search input is an address is increased when the search input includes a domain name, and the probability that the search input is a query is increased when the search input includes a space. The method also includes providing, for display, each of the suggestions according to the associated probability ranking value of the suggestion.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

The accompanying drawings, which are included to provide further understanding and are incorporated in and constitute a part of this specification, illustrate disclosed embodiments and together with the description serve to explain the principles of the disclosed embodiments. In the drawings:

FIG. 1 illustrates an example architecture for ranking search suggestions.

FIG. 2 is a block diagram illustrating an example client and server from the architecture of FIG. 1 according to certain aspects of the disclosure.

FIG. 3A illustrates an example process for ranking search suggestions using an example client of FIG. 2.

FIG. 3B illustrates an example Bayesian network associated with the example process of FIG. 3A.

FIG. 4 is a block diagram illustrating an example computer system with which the clients and server of FIG. 2 can be implemented.

### DETAILED DESCRIPTION

In the following detailed description, numerous specific details are set forth to provide a full understanding of the present disclosure. It will be apparent, however, to one ordinarily skilled in the art that the embodiments of the present disclosure may be practiced without some of these specific details. In other instances, well-known structures and techniques have not been shown in detail so as not to obscure the disclosure.

The disclosed system provides a user seeking to conduct a search with search suggestions from various sources that are ranked based on the probability that the suggestion is the user's intended search input and independent from the source of the suggestion. Specifically, based on an entered prefix, each suggestion is assigned a probably P (suggestion|prefix) according to the following formulas, the first formula for query-type suggestions and the second formula for URL-type suggestions:

P(query suggestion “x”|prefix)=P(a)*[P(b)*P(c)+((1−P(b))*P(d))], where
x=a search suggestion that suggests a query (e.g., “the words”) (and not a URL, such as wwx.words.com);
P(a)=likelihood of a user wanting to submit a search for a query (and not submit a URL), where P(a) may be:
   a global value (e.g., a global constant for all users) based on data from a plurality of users,
   a personalized value specific to the user based on data from the user's history (e.g., computed as: (number of times user issued a query)/(total number of queries and URLs issued by the user), or
   a value specific to the typed prefix, such as how many user navigations (e.g., queries or URLs visited from user history) that begin with the prefix are a query, divided by a total number of user navigations);
P(b)=likelihood of a search input the user is submitting being a query that the user has previously submitted, where P(b) may be:
   a manually set value (e.g., a global constant for all users based on data from a plurality of users),
   a personalized value specific to the user based on the user's historical behavior (e.g., computed as: (number of times the user issued a repeat query over the past n days)/(number of queries issued by the user over the past n days), or
   a value specific to the prefix, such as: (number of times the user typed the prefix and issued a repeat query over the last n days)/(number of times the user issued a query starting with the prefix over the last n days).
P(c)=a probability of the user issuing a repeat query “x” when typing the prefix, which is based on how many times the query “x” has been submitted by the user when typing the prefix in the last n days, divided by a count of how many times any query has been submitted by the user when typing the prefix in the last n days; and
P(d)=a probability of a user issuing a repeat query “x” when typing the prefix, which is based on of how many times the query “x” has been submitted by any user when typing the prefix in the last n days, divided by the count of how many times any query has been submitted by any user when typing the prefix in the last n days.

P(URL suggestion “y”|prefix)=P(f)*[P(g)*P(h)+((1−P(g))*P(i))], where
y=a search suggestion that suggests a URL;
P(f)=1−P(a)=likelihood of a user wanting to submit a search for a URL (and not submit a query), where P(f) may be:
   a global value (e.g., a global constant for all users) based on data from a plurality of users,
   a personalized value specific to the user based on data from the user's history (e.g., computed as: (number of times user issued a URL)/(total number of queries and URLs issued by the user), or
   a value specific to the typed prefix, such as how many user navigations (e.g., queries or URLs visited from user history) that begin with the prefix are a URL, divided by a total number of user navigations)
P(g)=likelihood of a search input the user is submitting being a URL that the user has previously submitted, where P(g) may be:
   a manually set value (e.g., a global constant for all users based on data from a plurality of users),
   a personalized value specific to the user based on the user's historical behavior (e.g., computed as: (number of times the user issued a repeat URL over the past n days)/(number of URLs issued by the user over the past n days), or
   a value specific to the prefix, such as: (number of times the user typed the prefix and issued a repeat URL over the last n days)/(number of times the user issued a URL starting with the prefix over the last n days);
P(h)=a probability of the user issuing a repeat URL “x” when typing the prefix, which is based on how many times the URL “x” has been submitted by the user when typing the prefix in the last n days, divided by a count of how many times any URL has been submitted by the user when typing the prefix in the last n days; and
P(i)=a probability of a user issuing a URL query “x” when typing the prefix, which is based on of how many times the URL “x” has been submitted by any user when typing the prefix in the last n days, divided by the count of how many times any URL has been submitted by any user when typing the prefix in the last n days.

Other parameters may also be used for P(c), P(d), P(h), and P(i). Additionally, a submitted query may be weighed by the manner in which the query was submitted. Thus, a query that is explicitly typed in and submitted twice may be counted twice, a query that is explicitly typed in once and then reissued by hitting “next page” could be given a lower weight, and a query that is reissued by hitting reload in an open window could be given an even lower weight. Similarly, if a query is reissued in a different mode (e.g., image search results versus web search results), the reissued query may be given a different weight.

By way of example for the equations above, a user types the search input prefix “th” (e.g., the prefix mentioned in the formulae above) in a search field. In the last n=30 days, the only search output, including queries and URLs, starting with “th” that have been issued by the user to the search engine are “thesaurus” 5 times, “the weather here” 8 times, and “thailand” 2 times. Also in the last n=30 days, the only search output, including queries and URLs, starting with “th” that have been issued by any user to the search engine are “thesaurus” 1000 times, “the dark rises” 500 times, and “thrifty” 100 times. Based on search history from a plurality of users over the last year, P(a)=⅓ and P(b)=0.2. The probability that the user intends the search input “thesaurus” by typing “th” is then:

$$\begin{matrix}P [ thesaurus \vert th ) = 1 / 3 * [ 0.2 * ( 5 / ( 5 + 8 + 2 ) ) + ( ( 1 - 0.2 ) * \\ ( 1000 / ( 1000 + 500 + 100 ) ) ] \\ = 0.188\end{matrix}$$

In certain aspects, P(a) or P(f) may be conditioned on the typed prefix. For example, the user typing in the prefix “www.” would increase probability of the user being interested in URL, or the user typing in the prefix “hello wo” would increase the probability of the user being interested in a query. In certain aspects, P(c), P(d), P(h), and P(i) may reflect how recently a search input was submitted by being time-decayed using a half-life parameter. For example, a half life of one week would permit a search result issued one week ago to contribute a frequency of 0.5, a search result issued two weeks ago would contribute a frequency of 0.25, and so on.

Although many examples provided herein describe a user's information (e.g., search history) being stored in memory, each user must grant explicit permission for such user information to be stored. The explicit permission may be granted using privacy controls integrated into the disclosed system. If requested user information includes demographic information, then the demographic information is aggregated on a group basis and not by individual user. Each user is provided notice that such user information will be stored with such explicit consent, and each user may at any time end having the user information stored, and may delete the stored user information. The stored user information may be encrypted to protect user security.

The user can at any time delete the user information from memory and/or opt out of having the user information stored in memory. Additionally, the user can, at any time, adjust appropriate privacy settings to selectively limit the types of user information stored in memory, or select the memory in which the user information is stored (e.g., locally on the user's device as opposed to remotely a server). In many examples, the user information does not include and/or share the specific identification of the user (e.g., the user's name) unless otherwise specifically provided or directed by the user.

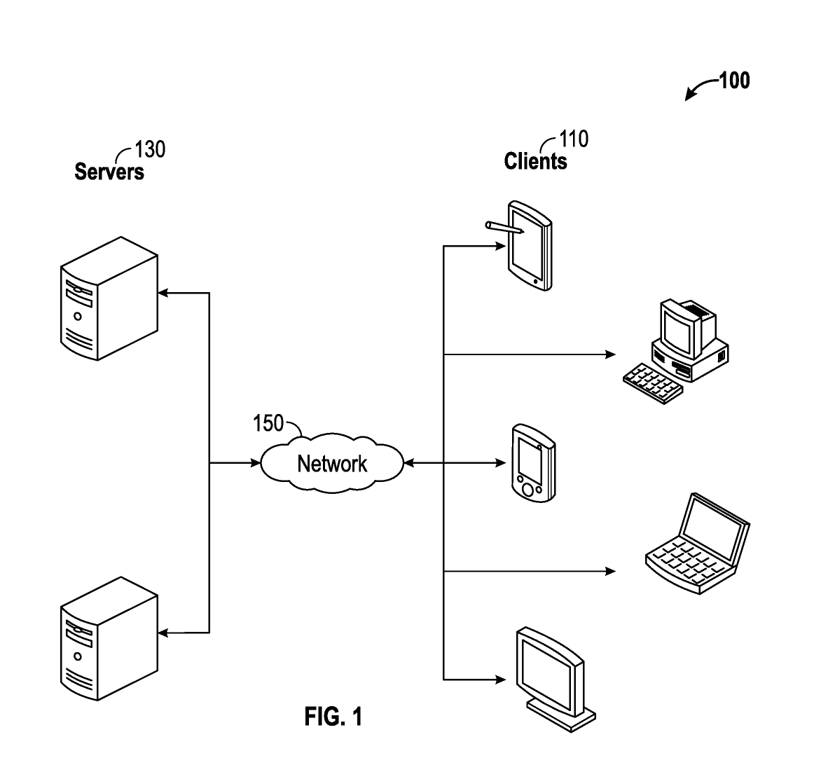

FIG. 1 illustrates an example architecture 100 for ranking search suggestions. The architecture 100 includes servers 130 and clients 110 connected over a network 150.

Each client 110 is configured to execute an application for viewing a document that includes a search input field. The clients 110 can be, for example, desktop computers, mobile computers, tablet computers (e.g., including e-book readers), mobile devices (e.g., a smartphone or PDA), set top boxes (e.g., for a television), video game consoles, or any other devices having appropriate processor, memory, and communications capabilities. The application can be, for example, a web browser, and the document can be, for example, a web page for an online search engine. When a user enters input into the search input field, whether a partial or complete input (e.g., a partial or complete word or web page address), the application displays search suggestions for the user based on the entered (but not yet submitted) input. The search suggestions may be, for example, queries (e.g., search terms or phrases) or web page addresses (e.g., URLs).

The search suggestions may be provided from various sources, including the user's search history (e.g., stored in local user history on the client), search results based on what the user has typed so far (e.g., stored in local user history on the client), or search suggestions from the history of other users based on what the user has typed so far (e.g., stored in global user history on a server 130). At least some of the search suggestions, such as search suggestions from the history of other users, may be provided over a network 150 from global user history stored on one or many of the servers 130. For purposes of load balancing, multiple servers 130 can host the global user history, either separately (e.g., as replicated copies) or in part.

The servers 130 can be any device having an appropriate processor, memory, and communications capability for the global user history. The network 150 can include, for example, any one or more of a personal area network (PAN), a local area network (LAN), a campus area network (CAN), a metropolitan area network (MAN), a wide area network (WAN), a broadband network (BBN), the Internet, and the like. Further, the network 150 can include, but is not limited to, any one or more of the following network topologies, including a bus network, a star network, a ring network, a mesh network, a star-bus network, tree or hierarchical network, and the like.

Each search suggestion has an associated probability ranking value (i.e., a probability that it is the intended search input of the user) that is independent of the source of the suggestion. The search suggestions are presented to the user in order of their associated probability ranking values. Thus, regardless of whether a search suggestion is from the history of other users based on what the user has input into the input field, or from the user's own search history, the search suggestion will be ordered among other search suggestions based on the search suggestion's associated probability ranking value.

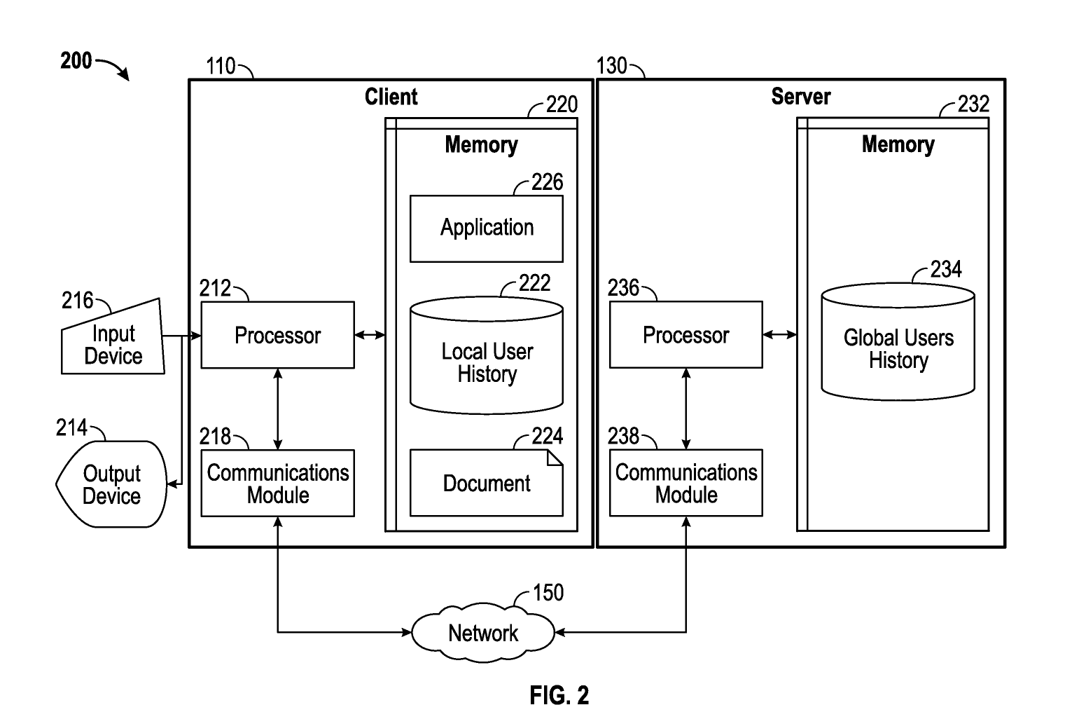

FIG. 2 is a block diagram 200 illustrating an example server 130 and client 110 in the architecture 100 of FIG. 1 according to certain aspects of the disclosure. The client 110 and the server 130 are connected over the network 150 via respective communications modules 218 and 238. The communications modules 218 and 238 are configured to interface with the network 150 to send and receive information, such as data, requests, responses, and commands to other devices on the network. The communications modules 218 and 238 can be, for example, modems or Ethernet cards.

The client 110 includes a processor 212, the communications module 218, and a memory 220 that includes an application 226 for viewing a document 224 that includes a search input field. The memory 220 also includes a user of the client's past history for the search input field that is stored as local user history 222. The local user history 222 can reference and otherwise download data over the network 150 from a global users history 234 stored in the memory 232 of a server 130 by the processor 236 of the server 130 sending the data from the communications module 238 of the server 130 to the communications module 218 of the client 110. The application 226 can be, for example, a web browser, a database viewer, a mobile app, or any other application 226 that can be configured for use with a search input field. The document 224 can be, for example, a web page, a database, content for a mobile app, or any other document 224 that can be configured to include a search input field. The client 110 also includes an input device 216 for receiving input for the search input field, such as a keyboard or mouse, and an output device 214, such as a display.

The processor 212 of the client 110 is configured to execute instructions, such as instructions physically coded into the processor 212, instructions received from software in memory 240, or a combination of both. For example, the processor 212 of the client 110 executes instructions for ranking search suggestions for display with the document 224 by the application 226. The processor 212 is configured to receive a search input, for instance, in an input field in the document 224 from a user. For example, the search input can be text for an incomplete or complete search query or address that is entered by a user using the input device 216 into a search field in a web page document 224 in a web browser application 226.

The processor 212 is also configured to identify at least one suggestion responsive to the search input from each of a plurality of suggestion sources. Each identified suggestion has an associated probability ranking value. For example, the associated probability ranking value of each suggestion can be based on a first count of how many times the suggestion has been provided to a user in a past certain number of days divided by a second count of how many times other suggestions that comprise the search input have been submitted by the user in the past certain number of days.

The associated probability ranking value is based on a likelihood that the search input is for a query, or a likelihood that the search input is for an address. For example, it is more likely that a user typing “wwx.go” is typing an address than a query, so a suggestion based on “wwx.go” would have an associated probability ranking that is indicating a likely address input. Each of the suggestions is provided for display according to the associated probability ranking value of the suggestion. For example, a suggestion, whether an address or a query, having a high probability ranking value will be displayed more prominently than a suggestion having a low probability ranking value. Prominence can be indicated, for example, by the order in which suggestions are displayed, the color or format in which the suggestions are displayed, or by various other display approaches. Similarly, suggestions based on the local user history 222 can be configured to be displayed more prominently (e.g., first) relative to suggestions from the global users history 234.

In certain aspects, an associated probability ranking value can be determined based on time (e.g., how recently a query or address was entered), a nature of how the query was issued (e.g., manually typed or clicked on in a result page related search suggestion), or a device from which the query issued (e.g., a smartphone, tablet, or desktop computer). As such, the number of issuances of a query from a search input field or search service can be logged for each user or for all users and weighed according to, for example, the platform or device on which the query was issued.

The associated probability ranking value of each suggestion can be based on a probability that the search input is an address or the search input is a query. Using the example provided above, it is more likely that a user typing “wwx.go” is typing an address than a query, so a suggestion based on “wwx.go” would have an associated probability ranking that is based on the user providing an address input. The probability that the search input is an address can be increased when the search input comprises a domain name, and the probability that the search input is a query is increased when the search input comprises a space. For example, it is more likely that a user that beings to type “wwx.gogogo.com” is entering an address input, and it is more likely that a user that begins to type “defying gravity” is entering a query input. The probability that the search input is an address or the search input is a query can be based on a search history of a plurality of users. For example, if the global users history 234 indicates that users typing “soc” are most likely intending to typing the address “socialnetworking.com,” then the probability that an individual user typing the input “soc” intends to type the address “socialnetworking.com” increases.

The associated probability ranking value of each suggestion can further be based on a probability that a search input is for a repeated address, repeated query, novel address, or novel query. The probability ranking value can be set specific to the user (e.g., local user history 222) or generalized to the history of all users (e.g., global users history 234). For example, if a user entering the query “steel” has entered the query “steelman” over ten times in the past, then the associated probability ranking value specific to the user of the query suggestion “steelman” is increased relative to if the user had never entered the query “steel” or “steelman” before. Furthermore, the associated probability ranking value of a suggestion can be time decayed. For example, if the user has not entered the query “steelman” in over two weeks, but more recently entered the query “steel bar,” then the associated probability ranking of the query suggestion “steelman” is decreased (or “decayed”) relative to the time it was last entered less than the associated probability ranking of the query suggestion “steel bar,” which was entered by the user more recently than the query “steelman.”

In certain aspects, the associated probability ranking value of a suggestion can be adjusted to be placed into a bucket category. For example, all suggestions having an associated probability ranking value between 1400 and 1600 can be assigned to a “1400” bucket in which each suggestion is consecutively valued as 1401, 1402, and so on. Similarly, all suggestions that are based on previous user entries can be given a value between 1000 to 1100 according to their associated probability ranking values. In certain aspects, a suggestion with an associated probability ranking value below a first threshold is assigned a first fixed ranking value, and a suggestion with an associated probability ranking value above a second threshold is assigned a second fixed ranking value. For example, a suggestion having an associated ranking value below the threshold 1000 can be assigned a value of at least 1000, and a suggestion having an associated ranking value above the threshold 1800 can be assigned a value no greater than 1800.

The suggestions can be provided from various sources, such as the user's search history, search results based on what the user has typed in the input field, or search suggestions for what the user has typed in the input field based on a search history of a plurality of other users. For example, if a user enters the query “super” into a search field of the document 224 and the local user history 222 indicates the user has entered the query “supermen” into a search field frequently in the past, then the search suggestion “supermen” can be provided from the user's search history. Similarly, if a user enters the query “frederick” into a search field of the document 224 and the global users history 234 indicated that users typing “frederick” most likely intend to type the query “frederick nietzsche,” then the search suggestion “frederick nietzsche” can be provided for display in the document 224.

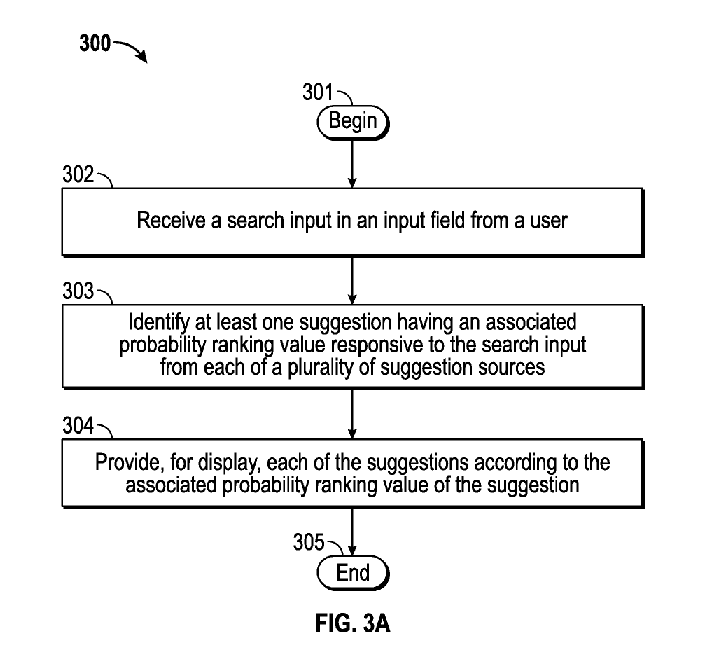

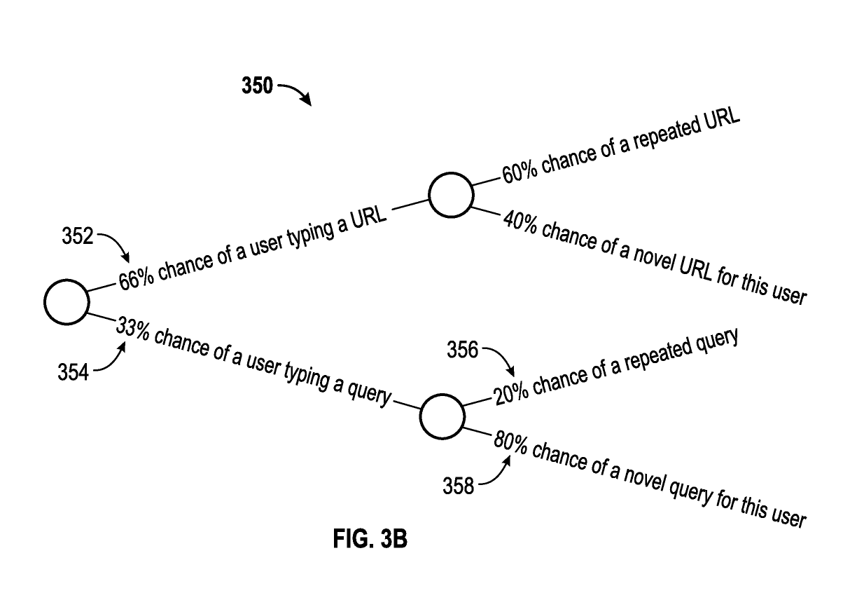

FIG. 3A illustrates an example process 300 for ranking search suggestions using the example client 110 of FIG. 2. While FIG. 3A is described with reference to FIG. 2, it should be noted that the process steps of FIG. 3A may be performed by other systems. The process 300 begins by proceeding from beginning step 301 when a user loads an application 226 on the client 110 to display a document 224, to step 302 in which a search input is received in an input field of the document 224 from the user. Next, in step 303, at least one suggestion having an associated probability ranking value responsive to the search input is identified from each of a plurality of suggestion sources. In step 304, each of the suggestions is provided for display according to the associated probability ranking value of the suggestion, and in step 305 the process 300 ends.

FIG. 3A set forth an example process 300 for ranking search suggestions using the example client 110 of FIG. 2. An example will now be described using the example process 300 of FIG. 3A using an application 226 that is a web browser and a document 224 that is a search page.

The process 300 begins by proceeding from beginning step 301 when a user loads a web browser 226 on the client 110 to display a search page 224 for “wwx.search.com,” to step 302 in which a search input “fa” is received in a search input field of the search page 224 from the user.

Next, in step 303, at least one suggestion having an associated probability ranking value responsive to the search input is identified from each of a plurality of suggestion sources. The associated probability ranking scores are computed in a probabilistic fashion, and then scaled to a value between a certain range, such as a value between 600 to 1400. It is noted that the example value range of 600 to 1400 is arbitrary and used as an example only. The associated probability ranking for the query “faceoff” is hardcoded to be at least 600. In the last thirty days, the only queries starting with “fa” that have been issued on wwx.search.com are “faceoff” with frequency (i.e., count) of 1000, “fanmango” with a frequency of 500, and “fathers day” with a frequency of 100. The local user history 222 indicates that the following queries beginning with “fa” have previously been submitted: “faceoff” with frequency of 5 (a value which can be time decayed) (this may or may not be the time decayed count we talked about), “family guy” with a frequency of 8, and “farmers vegetables” with a frequency of 2. As illustrated in the example Bayesian network 350 of FIG. 3B, the probability of an input being a query 354 is assigned to be 33%, and therefore the probability of an input being an address (e.g., URL) 352 is 66%. The probability 356 of an input being a repeat query 356 is assigned to be 20%, and the probability of an input being a new query 358 is assigned to be 80%. The assigned values can be configured to be specific to a user or search input. The probabilistic score for the suggestion “faceoff” given the input “fa” is computed as:

$$\begin{matrix}P [ faceoff \vert fa ) = P ( user wants query ) * [ P ( repeat query ) * \\ P [ faceoff \vert fa ) \_user \_history + P [ new query ] * \\ P [ faceoff \vert fa ) \_global ) \\ = 33 \% * [ .2 * 5 / ( 5 + 8 + 2 ) + 0.8 * 1000 / \\ ( 1000 + 500 + 100 ) ] \\ = 0.188\end{matrix}$$

Thus, the probabilistic score that the user intends to enter the input “faceoff” given the user's current input of “fa” is 19%. Any remaining suggestions are calculated using a similar process. Suggestions provided from the server 130 and based on the global users history 234 are assigned a value in a range between 600 to 1400. A minimum probability threshold for the suggestions is configured to be 0.05 and a maximum probability threshold for the suggestions is configured to be 0.5, so suggestions having probability scores below 0.05 are assigned a score of 600++(e.g., 600, 601, 602, etc.), and suggestions with greater than a 50% probability are assigned a score 1400++(e.g., 1400, 1401, 1402, etc.). For suggestions having a probability value in between 0.05 and 0.5, such as the 0.188 probability value for “faceoff” given the input “fa” described above, the probability value can be assigned a scaled score interpolated linearly as:

$$= 600 + ( .188 - .05 ) / ( .5 - .05 ) * ( 1400 - 600 ) \\ = 845.33$$

To prevent disclosing an exact value of the probability score, scores are optionally “bucketized” in order to prevent exposure of specific probability scores by assigning a value to a multiple of 50 between 600 and 1400. For example, the value 845.33 is rounded down to the nearest 50, so the final score for the suggestion “faceoff” given the input “fa” is 800.

In step 304, each of the suggestions is provided for display. The suggestions, whether addresses or queries, are sorted by probability value and displayed to the user accordingly. The process 300 then ends in step 305.

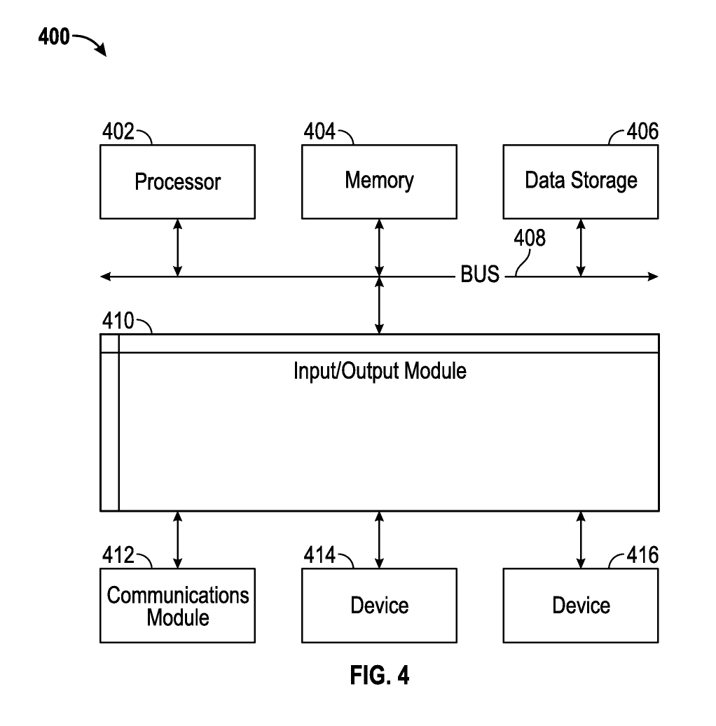

FIG. 4 is a block diagram illustrating an example computer system 400 with which the client 110 and server 130 of FIG. 2 can be implemented. In certain aspects, the computer system 400 may be implemented using hardware or a combination of software and hardware, either in a dedicated server, or integrated into another entity, or distributed across multiple entities.

Computer system 400 (e.g., client 110 and server 130) includes a bus 408 or other communication mechanism for communicating information, and a processor 402 (e.g., processor 212 and 236) coupled with bus 408 for processing information. By way of example, the computer system 400 may be implemented with one or more processors 402. Processor 402 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information.

Computer system 400 can include, in addition to hardware, code that creates an execution environment for the computer program in question, e.g., code that constitutes processor firmware, a protocol stack, a database management system, an operating system, or a combination of one or more of them stored in an included memory 404 (e.g., memory 220 and 232), such as a Random Access Memory (RAM), a flash memory, a Read Only Memory (ROM), a Programmable Read-Only Memory (PROM), an Erasable PROM (EPROM), registers, a hard disk, a removable disk, a CD-ROM, a DVD, or any other suitable storage device, coupled to bus 408 for storing information and instructions to be executed by processor 402. The processor 402 and the memory 404 can be supplemented by, or incorporated in, special purpose logic circuitry.

The instructions may be stored in the memory 404 and implemented in one or more computer program products, i.e., one or more modules of computer program instructions encoded on a computer readable medium for execution by, or to control the operation of, the computer system 400, and according to any method well known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, wirth languages, embeddable languages, and xml-based languages. Memory 404 may also be used for storing temporary variable or other intermediate information during execution of instructions to be executed by processor 402.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network. The processes and logic flows described in this specification can be performed by one or more programmable processors executing one or more computer programs to perform functions by operating on input data and generating output.

Computer system 400 further includes a data storage device 406 such as a magnetic disk or optical disk, coupled to bus 408 for storing information and instructions. Computer system 400 may be coupled via input/output module 410 to various devices. The input/output module 410 can be any input/output module. Example input/output modules 410 include data ports such as USB ports. The input/output module 410 is configured to connect to a communications module 412. Example communications modules 412 (e.g., communications module 218 and 238) include networking interface cards, such as Ethernet cards and modems. In certain aspects, the input/output module 410 is configured to connect to a plurality of devices, such as an input device 414 (e.g., input device 216) and/or an output device 416 (e.g., output device 214). Example input devices 414 include a keyboard and a pointing device, e.g., a mouse or a trackball, by which a user can provide input to the computer system 400. Other kinds of input devices 414 can be used to provide for interaction with a user as well, such as a tactile input device, visual input device, audio input device, or brain-computer interface device. For example, feedback provided to the user can be any form of sensory feedback, e.g., visual feedback, auditory feedback, or tactile feedback; and input from the user can be received in any form, including acoustic, speech, tactile, or brain wave input. Example output devices 416 include display devices, such as a LED (light emitting diode), CRT (cathode ray tube), or LCD (liquid crystal display) screen, for displaying information to the user.

According to one aspect of the present disclosure, the client 110 and server 130 can be implemented using a computer system 400 in response to processor 402 executing one or more sequences of one or more instructions contained in memory 404. Such instructions may be read into memory 404 from another machine-readable medium, such as data storage device 406. Execution of the sequences of instructions contained in main memory 404 causes processor 402 to perform the process steps described herein. One or more processors in a multi-processing arrangement may also be employed to execute the sequences of instructions contained in memory 404. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. The communication network (e.g., network 150) can include, for example, any one or more of a personal area network (PAN), a local area network (LAN), a campus area network (CAN), a metropolitan area network (MAN), a wide area network (WAN), a broadband network (BBN), the Internet, and the like. Further, the communication network can include, but is not limited to, for example, any one or more of the following network topologies, including a bus network, a star network, a ring network, a mesh network, a star-bus network, tree or hierarchical network, or the like. The communications modules can be, for example, modems or Ethernet cards.

Computing system 400 can include clients and servers. A client and server are generally remote from each other and typically interact through a communication network. The relationship of client and server arises by virtue of computer programs running on the respective computers and having a client-server relationship to each other. Computer system 400 can be, for example, and without limitation, a desktop computer, laptop computer, or tablet computer. Computer system 400 can also be embedded in another device, for example, and without limitation, a mobile telephone, a personal digital assistant (PDA), a mobile audio player, a Global Positioning System (GPS) receiver, a video game console, and/or a television set top box.

The term “machine-readable storage medium” or “computer readable medium” as used herein refers to any medium or media that participates in providing instructions or data to processor 402 for execution. Such a medium may take many forms, including, but not limited to, non-volatile media, volatile media, and transmission media. Non-volatile media include, for example, optical disks, magnetic disks, or flash memory, such as data storage device 406. Volatile media include dynamic memory, such as memory 404. Transmission media include coaxial cables, copper wire, and fiber optics, including the wires that comprise bus 408. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read. The machine-readable storage medium can be a machine-readable storage device, a machine-readable storage substrate, a memory device, a composition of matter effecting a machine-readable propagated signal, or a combination of one or more of them.

As used herein, the phrase “at least one of” preceding a series of items, with the terms “and” or “or” to separate any of the items, modifies the list as a whole, rather than each member of the list (i.e., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

Furthermore, to the extent that the term “include,” “have,” or the like is used in the description or the claims, such term is intended to be inclusive in a manner similar to the term “comprise” as “comprise” is interpreted when employed as a transitional word in a claim.

A reference to an element in the singular is not intended to mean “one and only one” unless specifically stated, but rather “one or more.” The term “some” refers to one or more. Underlined and/or italicized headings and subheadings are used for convenience only, do not limit the subject technology, and are not referred to in connection with the interpretation of the description of the subject technology. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products.

The subject matter of this specification has been described in terms of particular aspects, but other aspects can be implemented and are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous. Other variations are within the scope of the following claims.

These and other implementations are within the scope of the following claims.

What is claimed is:

1. A computer-implemented method for ranking search suggestions, the method comprising:
receiving a search input;
identifying at least one suggestion responsive to the search input from each of a plurality of suggestion sources, wherein each suggestion has an associated probability ranking value based on a likelihood that the search input is for a query or a likelihood that the search input is for an address; and
providing, for display, each of the suggestions according to the associated probability ranking value of the suggestion.

2. The method of claim 1, wherein the search input is received in an input field from a user, and wherein the plurality of suggestion sources comprises a query or address from the user's search history, search results based on what the user has typed in the input field, or search suggestions for what the user has typed in the input field based on a search history of a plurality of other users.

3. The method of claim 1, wherein the associated probability ranking value of each suggestion is further based on a probability that the search input is an address or the search input is a query.

4. The method of claim 3, wherein the probability that the search input is an address is increased when the search input comprises a domain name, and the probability that the search input is a query is increased when the search input comprises a space.

5. The method of claim 3, wherein the probability that the search input is an address or the search input is a query is based on a search history of a plurality of users.

6. The method of claim 3, wherein the associated probability ranking value of each suggestion is further based on a probability that the search input is for a repeated address, repeated query, novel address, or novel query.

7. The method of claim 6, wherein the search input is received from a user, and wherein the probability that the search input is a repeated address, repeated query, novel address, or novel query is set specific to the user.

8. The method of claim 1, wherein the associated probability ranking value of each suggestion is time decayed based on how recently the suggestion was issued.

9. The method of claim 1, wherein the associated probability ranking value of each suggestion is adjusted to be placed into bucket categories.

10. The method of claim 1,
wherein the search input is received by a user on a device,
wherein a first suggestion listed among the suggestions provided for display is provided by the device for display,
wherein another suggestion based on a search history of other users listed among the suggestions provided for display is received from a server, and
wherein the other suggestion is provided for display among the list of suggestions without removing the position of the first suggestion listed among the suggestions.

11. The method of claim 1, wherein the associated probability ranking value of each suggestion is further based on a first count of how many times the suggestion has been provided to at least one user in a past certain number of days divided by a second count of how many times other suggestions that comprise the search input have been submitted by the at least one user in the past certain number of days.

12. The method of claim 1, wherein a suggestion with an associated probability ranking value below a first threshold is assigned a first fixed ranking value, and a suggestion with an associated probability ranking value above a second threshold is assigned a second fixed ranking value.

13. A system for ranking search suggestions, the system comprising:
a memory comprising instructions;
a processor configured to execute the instructions to:
receive a search input in an input field from a user;
identify at least one suggestion responsive to the search input from each of a plurality of suggestion sources comprising a query or address from the user's search history, search results based on what the user has typed in the input field, or search suggestions for what the user has typed in the input field based on a search history of a plurality of other users, wherein each suggestion has an associated probability ranking value based on a likelihood that the search input is for a query or a likelihood that the search input is for an address; and
provide, for display, each of the suggestions according to the associated probability ranking value of the suggestion.

14. The system of claim 13, wherein the associated probability ranking value of each suggestion is further based on a probability that the search input is an address or the search input is a query.

15. The system of claim 14,
wherein the probability that the search input is an address is increased when the search input comprises a domain name, and the probability that the search input is a query is increased when the search input comprises a space,
wherein the probability that the search input is an address or the search input is a query is based on a search history of a plurality of users, and
wherein the associated probability ranking value of each suggestion is further based on a probability that the search input is for a repeated address, repeated query, novel address, or novel query.

16. The system of claim 15, wherein the probability that the search input is a repeated address, repeated query, novel address, or novel query is set specific to the user.

17. The system of claim 13, wherein the associated probability ranking value of each suggestion is time decayed based on how recently the suggestion was issued.

18. The system of claim 13, wherein the associated probability ranking value of each suggestion is adjusted to be placed into bucket categories.

19. The system of claim 13,
wherein the search input is received on a device,
wherein a first suggestion listed among the suggestions provided for display is provided by the device for display,
wherein another suggestion based on a search history of other users listed among the suggestions provided for display is received from a server, and
wherein the other suggestion is provided for display among the list of suggestions without removing the position of the first suggestion listed among the suggestions.

20. The system of claim 13, wherein the associated probability ranking value of each suggestion is further based on a first count of how many times the suggestion has been provided to at least one user in a past certain number of days divided by a second count of how many times other suggestions that comprise the search input have been submitted by the at least one user in the past certain number of days.

21. The system of claim 13, wherein a suggestion with an associated probability ranking value below a first threshold is assigned a first fixed ranking value, and a suggestion with an associated probability ranking value above a second threshold is assigned a second fixed ranking value.

22. A machine-readable storage medium comprising machine-readable instructions for causing a processor to execute a method for ranking search suggestions, the method comprising:
receiving a search input in an input field on a device from a user;
identifying at least one suggestion responsive to the search input from each of a plurality of suggestion sources comprising a query or address from the user's search history, search results based on what the user has typed in the input field, or search suggestions for what the user has typed in the input field based on a search history of a plurality of other users,
wherein each suggestion has an associated probability ranking value based on: a likelihood that the search input is for a query or a likelihood that the search input is for an address, a probability, based on a search history of a plurality of users, that the search input is for a repeated address, repeated query, novel address, or novel query set specific to the user,
wherein the probability that the search input is an address is increased when the search input comprises a domain name, and the probability that the search input is a query is increased when the search input comprises a space; and
providing, for display, each of the suggestions according to the associated probability ranking value of the suggestion.
